(19) United States
(12) Patent Application Publication
(10) Pub. No.: US 2025/0328117 A1
(43) Pub. Date: Oct. 23, 2025

(54) Compass Bird Control Method and Apparatus

(71) Applicant: China Oilfield Services Ltd., Binhai New Area Tianjin (CN)

(72) Inventors: Zhongwu Jing, Tianjin (CN); Zhenbo Wang, Tianjin (CN); Fuming Ruan, Tianjin (CN); Zhirui Wang, Tianjin (CN); Haonan Zhang, Tianjin (CN); Zhengkun Li, Tianjin (CN); Yi Han, Tianjin (CN); Deyou Huang, Tianjin (CN); Wenxuan Li, Tianjin (CN); Yongcheng Qiu, Tianjin (CN); Ruifang Duan, Tianjin (CN)

(73) Assignee: China Oilfield Services Ltd., Binhai New Area Tianjin (CN)

(21) Appl. No.: 18/867,625

(22) PCT Filed: Mar. 3, 2023
(86) PCT No.: PCT/CN2023/079673

§ 371 Date: Nov. 20, 2024

(30) Foreign Application Priority Data
May 24, 2022 (CN) 202210570336.6

(51) Int. Cl. G05B 19/042

(52) U.S. Cl. CPC G05B 19/042; G05B 2219/25257

(57) ABSTRACT

The present application disclosure a method A method and device for controlling a compass bird. The method includes: a main control single-chip microcomputer entering a first deep sleep mode when not processing a task; the main control single-chip microcomputer switching from the first deep sleep mode to a first working mode after receiving an external interrupt signal; a peak detection circuit detecting whether there is a communication carrier signal; a data demodulation unit not starting if the peak detection circuit detects that there is no communication carrier signal; and the data demodulation unit starting to demodulate the communication carrier signal if the peak detection circuit detects that there is the communication carrier signal, and a communication demodulation module sending a demodulated signal to the main control single-chip microcomputer.

### CROSS REFERENCE TO RELATED APPLICATIONS

This application claims priority to Chinese Patent Application No. 2022105703366, titled “METHOD AND DEVICE FOR CONTROLLING A COMPASS BIRD”, filed on May 24, 2022 with the China National Intellectual Property Administration, the entire contents of which are incorporated herein by reference.

### TECHNICAL FIELD

The present disclosure belongs to the field of exploration and surveying technology and specifically involves a method and device for controlling a compass bird.

### BACKGROUND

With the development of marine oil exploration technology towards wide-frequency and wide-azimuth, exploration system requires seismometers to have more accurate positioning capabilities. Seismometers arranged according to different depths can obtain more abundant stratigraphic imaging maps by collecting seismic wave data with wide-frequency information, which is of great significance for geological data interpretation and oil and gas exploration. However, if the seismometer is not accurately and steadily sunk at different depths, the collected stratigraphic data cannot be continuously imaged and may even be unreliable. Therefore, it is necessary to improve the wide-frequency characteristics of the seismometers and control the depth of a towed cable accurately in order to collect and analyze the wide-frequency geological profile data. Compass bird is the necessary professional equipment for seismic operation of marine towed cable. To control the depth of different parts of the towed cable by via compass bird, the compass bird is required to have strong depth maintenance ability and rapid response ability. The need for sinking at different depths requires that the compass bird adjust its wing plate angles more frequently to maintain depth, which results in increased power consumption and more frequent battery replacement for the compass bird.

Therefore, it is necessary to design a method and device for controlling the compass bird to overcome the aforementioned issues.

### SUMMARY

Given the above issues, this disclosure provides a method and device for controlling a compass bird to solve the problem of high power consumption in the prior art.

According to one aspect of the present disclosure, a method for controlling a compass bird is provided, the method comprising:

a main control single-chip microcomputer entering a first deep sleep mode when not processing a task;

the main control single-chip microcomputer switching from the first deep sleep mode to a first working mode after receiving an external interrupt signal;

a peak detection circuit detecting whether there is a communication carrier signal;

a data demodulation unit not starting if the peak detection circuit detects that there is no communication carrier signal; and

the data demodulation unit starting to demodulate the communication carrier signal if the peak detection circuit detects that there is the communication carrier signal, and a communication demodulation module sending a demodulated signal to the main control single-chip microcomputer.

In some embodiments, the external interrupt signal includes a first external interrupt signal, and the main control single-chip microcomputer switching from the first deep sleep mode to a first working mode after receiving an external interrupt signal further comprises:

the main control single-chip microcomputer receiving the first external interrupt signal to perform AD sampling;

and/or, the external interrupt signal including a second external interrupt signal, and the main control single-chip microcomputer switching from the first deep sleep mode to a first working mode after receiving an external interrupt signal further comprises:

the main control single-chip microcomputer receiving the second external interrupt signal and communicating with a communication module and/or a motor control module.

In some embodiments, the second external interrupt signal includes a first communication interrupt signal and a second communication interrupt signal, and the main control single-chip microcomputer receiving the second external interrupt signal and communicating with a communication module and/or a motor control module further comprises:

the main control single-chip microcomputer receiving the first communication interrupt signal and communicating with the communication module; and

the main control single-chip microcomputer receiving the second communication interrupt signal and communicating with the motor control module.

In some embodiments, the method further comprises:

the motor single-chip microcomputer entering a second deep sleep mode when not processing a task;

the motor single-chip microcomputer receiving the first external interrupt signal and controlling operations of a motor and/or a compass;

and/or, the motor single-chip microcomputer receiving the second external interrupt signal and communicating with the main control single-chip microcomputer and/or the compass.

In some embodiments, the method further comprises:

a first comparison circuit detecting whether a voltage of a first battery is greater than a switching reference voltage, wherein a voltage range of the switching reference voltage corresponds to a voltage range when the remaining battery capacity of the first battery is 20%-30%;

the first battery keeping working and a second battery not starting if the first comparison circuit detects that the voltage of the first battery is greater than the switching reference voltage; and

the first battery keeping working and the second battery starting working if the first comparison circuit detects that the voltage of the first battery is less than the switching reference voltage.

According to another aspect of the present disclosure, a device for controlling a compass bird comprising:

a main control single-chip microcomputer, configured to enter a first deep sleep mode when not processing a task, and switch from the first deep sleep mode to a first working mode after receiving an external interrupt signal;

a communication module comprising a communication demodulation module connected to the main control single-chip microcomputer and configured to demodulate the communication carrier signal from an upper computer, wherein the communication demodulation module comprises a peak detection circuit and a data demodulation unit, and the peak detection circuit is configured to detect whether there is a communication carrier signal;

if the peak detection circuit detects that there is no communication carrier signal, the data demodulation unit does not start;

if the peak detection circuit detects that there is the communication carrier signal, the data demodulation unit starts to demodulate the communication carrier signal, and the communication demodulation module sends a demodulated signal to the main control single-chip microcomputer.

In some embodiments, the main control single-chip microcomputer includes an AD sampling module, the external interrupt signal includes a first external interrupt signal, and when the main control single-chip microcomputer receives the first external interrupt signal, the AD sampling module performs AD sampling;

and/or, the external interrupt signal includes a second external interrupt signal, and the main control single-chip microcomputer receives the second external interrupt signal to communicate with the communication module and/or motor control module.

In some embodiments, the motor control module includes a motor single-chip microcomputer, a motor, and a compass, the motor and the compass both connect to the motor single-chip microcomputer, and the motor single-chip microcomputer enters a second deep sleep mode when not processing a task;

the motor single-chip microcomputer receives the first external interrupt signal and controls operations of the motor and/or compass;

and/or, the motor single-chip microcomputer receives the second external interrupt signal and communicates with the main control single-chip microcomputer and/or the compass.

In some embodiments, the device for controlling a compass bird further comprises a power module, and a first trigger switch is connected in series between the power module and the data demodulation unit;

the communication demodulation module further includes a pre-signal processing unit configured to process the communication carrier signal before demodulation, and the peak detection circuit and the data demodulation unit are both connected to the pre-signal processing unit;

if the peak detection circuit detects that there is the communication carrier signal, the peak detection circuit outputs a first control level to close the first trigger switch to cause the data demodulation unit to start.

In some embodiments, the pre-signal processing unit includes a network matching unit, a filter amplification unit connected to the network matching unit, and a differential amplification unit connected to the filter amplification unit, and the peak detection circuit and the data demodulation unit are both connected to the differential amplification unit.

In some embodiments, the power module includes a battery pack and a power circuit, and the power circuit includes a switching circuit of the battery and an output circuit connected in series with the switching circuit of the battery;

the battery pack includes a first battery and a second battery, the second battery is connected in parallel with the first battery, and the first battery is connected to the output circuit;

the switching circuit of the battery includes a first comparison circuit and a second trigger switch, wherein a switching reference voltage is input to the inverting input end of the first comparison circuit, the non-inverting input end of the first comparison circuit is connected to the first battery, the output end of the first comparison circuit is connected to the control end of the second trigger switch, the second battery is connected to the output circuit via the second trigger switch, and the first comparison circuit is configured to detect whether the voltage of the first battery is greater than the switching reference voltage, wherein a voltage range of the switching reference voltage corresponds to a voltage range when the remaining battery capacity of the first battery is 20%-30%;

if the first comparison circuit detects that the voltage of the first battery is greater than the switching reference voltage, the second trigger switch is in an off state, the first battery keeps working and the second battery does not start; and if the first comparison circuit detects that the voltage of the first battery is less than the

switching reference voltage, the first comparison circuit outputs a second control level to trigger the second trigger switch to close, thereby the second battery starts to work

In some embodiments, the power circuit further comprises a bus circuit connected to the output circuit, the output circuit includes a first output branch and a second output branch, an input end of the first output branch is connected to the battery switching circuit, the second output branch includes a second comparison circuit, a boost regulator circuit, and a third trigger switch, a non-inverting input end of the second comparison circuit is connected to an output end of the first output branch, a starting reference voltage is input to an inverting input end of the second comparison circuit, an output end of the second comparison circuit is connected to a control end of the third trigger switch, the battery switching circuit is connected to the boost regulator circuit via the third trigger switch, and the second comparison circuit is configured to detect whether the voltage of the battery switching circuit is greater than the starting reference voltage, wherein the starting reference voltage is the output voltage of the bus circuit;

if the second comparison circuit detects that the voltage of the battery switching circuit is greater than the starting reference voltage, the third trigger switch is in an off state, and the boost regulator circuit does not work; and

if the second comparison circuit detects that the voltage of the battery switching circuit is less than the starting reference voltage, the second comparison circuit outputs a third control level to close the third trigger switch so that the boost regulator circuit works.

In the exemplary embodiment of the present disclosure, the main control single-chip microcomputer is controlled to enter the first deep sleep mode when it is not processing a task, and the main control single-chip microcomputer receives an external interrupt signal and switches from the first deep sleep mode to the first working mode, thus the internal interrupt method of the main control single-chip microcomputer is removed, and the main control single-chip microcomputer can enter deeper levels of dormancy, reducing the power consumption of the main control single-chip microcomputer. Additionally, the peak detection circuit detects whether there is a communication carrier signal among the signals of communication demodulation module so that on-off state of the data demodulation unit can be controlled. Since the power consumption of the peak detection circuit is significantly lower than that of the data demodulation unit, the setup of the peak detection circuit can prevent the data demodulation unit from running continuously, thus reducing the overall power consumption of the communication demodulation module. The power consumption control method for main control single-chip microcomputer and the communication demodulation module substantially reduces the power consumption of the compass bird, thereby decreasing the frequency of battery replacement of the compass bird, extending the underwater operational time of the compass bird, and improving the operation efficiency of the compass bird.

The above description is merely an overview of the technical solution of the exemplary embodiment of the present disclosure. To better understand the technical means of this exemplary embodiment, one should refer to the content of the specification for implementation. Furthermore, to make the aforementioned and other purposes, features, and advantages of the exemplary embodiment of the present disclosure more apparent and understandable, the following provides specific implementation examples.

### BRIEF DESCRIPTION OF THE DRAWINGS

The drawings are provided only to illustrate the implementation methods and are not

considered restrictive of the present disclosure. Throughout the drawings, the same reference signs represent the same components. In the drawings:

FIG. 1 illustrates a flowchart of the method for controlling a compass bird provided by the exemplary embodiment of the present disclosure;

FIG. 2 illustrates a structural diagram of the a device for controlling a compass bird provided by the exemplary embodiment of the present disclosure;

FIG. 3 illustrates a structural diagram of the communication demodulation module provided by the exemplary embodiment of the present disclosure;

FIG. 4 illustrates a structural diagram of the peak detection circuit provided by the exemplary embodiment of the present disclosure;

FIG. 5 illustrates a structural diagram of the motor control module provided by the exemplary embodiment of the present disclosure;

FIG. 6 shows a structural diagram of the H-bridge circuit provided by the exemplary embodiment of the present disclosure; and

FIG. 7 illustrates a structural diagram of the power module provided by the exemplary embodiment of the present disclosure.

### REFERENCE SIGNS EXPLANATIONS

100: Main control module; 101: Main control single-chip microcomputer;

200: Communication module; 201: Communication demodulation module; 2011: Pre-signal processing unit; 2012: Network matching unit; 2013: Filter amplification unit; 2014: Differential amplification unit; 2015: Data demodulation unit; 2016: Peak detection circuit; 202: Communication modulation module;

300: Motor control module; 301: Motor single-chip microcomputer; 302: Compass; 303: Control unit; 304: Boost unit; 305: H-bridge circuit; 306: Optical isolation unit;

400: Power module; 401: Battery pack; 402: Power circuit; 403: Switching circuit of the battery; 4031: First comparison circuit; 404: Output circuit; 4041: Second comparison circuit; 4042: Boost regulator circuit; 405: Bus circuit; 4051: Buck regulator circuit;

500: Depth sensor;

600: Temperature sensor;

10: First trigger switch; 20: Second trigger switch; 30: Third trigger switch;

A: First battery;

B: Second battery;

M: Motor.

### DETAILED DESCRIPTION

The following will describe exemplary embodiments of the present disclosure in more detail with reference to the accompanying drawings. Although the exemplary embodiments of the present disclosure are shown in the drawings, it should be understood that the present disclosure can be implemented in various forms and should not be limited by the embodiments described herein.

Regarding the problem in the prior art that the need for sinking each parts of the towed cable at different depths requires that the compass bird adjust its wing plate angles more frequently to maintain depth, which results in increased power consumption and more frequent battery replacement for the compass bird, the inventor discovered that the existing compass bird mainly includes a main control module, a motor control module, a communication module, and a power module, and the total power of the compass bird is approximately 140 mW, the majority of this power being consumed by the main control module and the communication module.

Through analysis, the inventor found that the main control single-chip microcomputer in the main control module uses internal interrupts to wake itself up to work, and in this way, the timer and other parts of the main control single-chip microcomputer still work, the main control single-chip microcomputer is in the first level sleep mode and cannot enter deeper sleep mode, resulting in a shallow sleep level for the main control single-chip microcomputer. Meanwhile, other work processes (such as communication functions and data acquisition control ect.) are still in standby mode and have not been completely shut down, causing the main control single-chip microcomputer to consume a large amount of power even when in sleep mode. Similarly, the motor single-chip microcomputer in the motor control module also uses internal interrupts, resulting in high power consumption.

In the communication demodulation module, it is unknown when the upper computer sends a communication carrier signal, thus, in order to prevent communication errors, the data demodulation unit must run continuously even when no communication carrier signal from the upper computer has been received, causing increased power consumption of the data demodulation unit.

Furthermore, the power module includes a first battery and a second battery that serves as a backup battery, the voltage of the first battery is monitored by the main control single-chip microcomputer, and the switch to activate the second battery is controlled via a program. Since the main control single-chip microcomputer needs to continuously monitor the voltage of the first battery, this results in a waste of system resources of the main control single-chip microcomputer and increases power consumption.

Therefore, to address the power consumption issues identified by the inventor, the inventor changes the internal interrupt method used by the main control single-chip microcomputer and the motor single-chip microcomputer to an external interrupt method, allowing both microcomputers to enter a deep sleep mode to reduce their power consumption.

For the communication demodulation module, the inventor proposes setting a detection circuit to detect a communication carrier signal. The data demodulation unit only runs when a communication carrier signal is detected, thereby reducing the power consumption of the communication demodulation module.

Additionally, for the power module, the inventor cancels the monitoring of the power of the first battery by the main control single-chip microcomputer, and adopts a low-power detection circuit to monitor the battery, thus reducing the power consumption of the main control single-chip microcomputer.

Specific implementation examples are as follows.

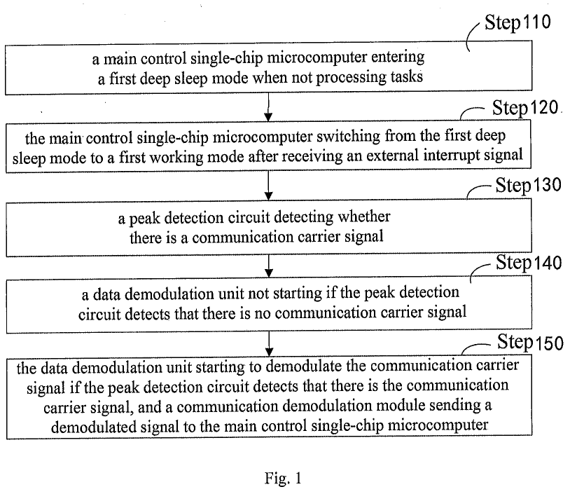

FIG. 1 shows a flowchart of the method for controlling a compass bird provided by the embodiment of the present disclosure. The method comprises the following steps.

Step 110: The main control single-chip microcomputer is controlled to enter the first deep sleep mode when it is not processing a task.

Step 120: The main control single-chip microcomputer receives an external interrupt signal and switches from the first deep sleep mode to the first working mode.

Step 130: The peak detection circuit detects whether there is a communication carrier signal.

Step 140: If the peak detection circuit detects that there is no communication carrier signal, the data demodulation unit does not start.

Step 150: If the peak detection circuit detects that there is the communication carrier signal, the data demodulation unit starts to demodulate the communication carrier signal, and the communication demodulation module sends the demodulated signal to the main control single-chip microcomputer.

In step 110, the main control single-chip microcomputer is controlled to enter the first deep sleep mode when it is not processing a task. At this time, various internal modules of the main control single-chip microcomputer stop operating, allowing the main control single-chip microcomputer to enter the second level, the third level, or deeper levels of dormancy, which depends on the performance of the microcomputer itself. For example, in some embodiments, the main control single-chip microcomputer can enter up to the third-level sleep mode, or in some embodiments, up to the fourth-level sleep mode. In this embodiment, the main control single-chip microcomputer is an MSP430F169 that can enter the fourth-level sleep mode (that is low-power mode 4), and in this mode, the current consumption of the main control single-chip microcomputer is 0.1 μA. Compared with 340 μA of current consumption when the main control single-chip microcomputer is in active mode, the power consumption of the main control single-chip microcomputer can be greatly reduced when the main control single-chip microcomputer is in low power mode 4.

In step 120, the internal interrupt method of the main control single-chip microcomputer is removed, requiring an external interrupt signal to trigger the main control single-chip microcomputer to work. The main control single-chip microcomputer receives the external interrupt signal and switches from the first deep sleep mode to the first working mode. In this embodiment, the frequency of the external interrupt signal is basically set to 2 Hz, triggering the main control single-chip microcomputer every 0.5 seconds. This 0.5 seconds is the minimum time interval for interaction between the main control single-chip microcomputer and other modules. When the main control single-chip microcomputer is triggered, if the main control single-chip microcomputer does not detect that there is work to be processed, it continues entering the first deep sleep mode; otherwise, it switches to the first working mode from the first deep sleep mode to start processing work, such as AD sampling (Analog to Digital sampling) including temperature, depth, battery voltage, and current sampling. After completing the current work, it re-enters the first deep sleep mode, waiting for the next external interrupt signal. In this embodiment, each AD sampling lasts 140 ms, no sampling occurs during wake-up every 0.5 seconds, and the wake-up period is about 10 ms. If a 2-second sampling interval is set, the duty cycle is (140 ms+20 ms)/2 s=8%, reducing power consumption by 92%. In other embodiments, the frequency of the external interrupt signal can be 4 Hz, with an interruption interval of 0.25 seconds, or the frequency of the external interrupt signal can be 1 Hz, with an interruption interval of 1 second, which can be set depending on the requirements and is not limited here. The higher the frequency of the external interrupt signal, the higher the frequency of interruptions and wake-up, and thus the higher the power consumption; the lower the frequency of the external interrupt signal, the lower the frequency of interruptions and wake-up, and the lower the power consumption.

Steps 130 to 150 involve the communication demodulation module in the communication module. The communication demodulation module is used to demodulate the communication carrier signal sent by an upper computer, and the communication carrier signal carries information to instruct the compass bird to take appropriate control. In this embodiment, the communication carrier signal is a sine wave, and the communication carrier signal sent by the upper computer is an FSK modulated signal. When no signal is sent, it is at the reference 0 level. The carrier signal has a peak value during communication. In other embodiments, the communication carrier signal can be ASK signals, PSK signals, or pulse signals, as long as the signal have periodic peaks.

A peak detection circuit is set to detect whether the signal in the communication demodulation module has peaks. If peaks in the siganl are detected, it is considered that the signal is the communication carrier signal sent by the upper computer. The peak detection circuit outputs a control level to power and start the data demodulation unit in the data communication demodulation module to demodulate the communication carrier signal. The communication carrier signal is demodulated to obtain a demodulated signal. The communication demodulation module sends the demodulated signal to the main control single-chip microcomputer. After receiving the demodulated signal, the main control single-chip microcomputer is triggered by the external interrupt signal to enter the first working mode and processes the task accordingly based on the content of the demonstrated signal. The content of the demodulated signal includes obtaining heading information and depth information of the compass bird, and instructing a specific depth at which the compass bird dives under water, etc. The main control single-chip microcomputer then controls the compass for measurements, activates the depth sensor, and drives motors, etc. Then, the main control single-chip microcomputer sends the obtained heading and depth information modulated by a communication modulation module back to the upper computer. If no peaks are detected, it is assumed that the upper computer did not send a communication carrier signal, and the data demodulation unit remains powered off and does not activate. The power consumption of the peak detection circuit is much smaller than that of the data demodulation unit. The setting of this peak detection circuit can prevent the data demodulation unit from running continuously, thereby reducing the power consumption of the communication demodulation module and roughly reducing the power consumption of the communication demodulation module by 20 mW.

Through the above steps 110 to 150, by controlling the power consumption of the main control single-chip microcomputer and the communication demodulation module, the power consumption of the compass bird can be significantly reduced, decreasing the frequency of battery replacement of the compass bird, extending the underwater working time of the compass bird, and improving its operational efficiency.

In some embodiments, the external interrupt signal includes a first external interrupt signal. Step 120 further includes the following steps.

Step a01: The main control single-chip microcomputer receives the first external interrupt signal and performs AD sampling.

The first external interrupt signal is an IO interrupt signal and not a communication interrupt signal. The first external interrupt signal triggers the main control single-chip microcomputer to switch from the first deep sleep mode to the first working mode to process non-communication tasks, primarily AD sampling, such as temperature sampling, depth sampling, battery voltage sampling, and work current sampling. The AD sampling converts the analog signals of the depth sensors, the temperature sensors, the voltage of the battery modules and the working current into digital signals. Subsequently, the main control single-chip microcomputer sends the digital information obtained from AD sampling back to the upper computer. In this embodiment, the frequency of the first external interrupt signal is 2 Hz.

In some embodiments, the external interrupt signal further includes a second external interrupt signal. Steps 110 and 120 further include the following steps.

Step a02: The main control single-chip microcomputer receives the second external interrupt signal and communicates with the communication module and/or the motor control module 300.

The second external interrupt signal is a communication interrupt signal used to trigger the main control single-chip microcomputer to communicate with other modules including the communication module and/or the motor control module. During the first working mode, the main control single-chip microcomputer performs communication tasks. The frequency of the second external interrupt signal can be the same as the first external interrupt signal, i.e., 2 Hz, or they can be different, which can be set depending on the requirements and is not limited here.

The first external interrupt signal and the second external interrupt signal can simultaneously trigger the main control single-chip microcomputer to perform corresponding tasks, or they can trigger the main control single-chip microcomputer separately, which can be set depending on the requirements and is not limited here.

In some embodiments, the second external interrupt signal includes a first communication interrupt signal and a second communication interrupt signal. Step a02 further includes the following steps.

Step a021: The main control single-chip microcomputer receives the first communication interrupt signal and communicates with the communication module.

Step a022: The main control single-chip microcomputer receives the second communication interrupt signal and communicates with the motor control module.

The first communication interrupt signal is used to trigger the main control single-chip microcomputer to communicate with the communication module, including communication with the communication demodulation module and the communication modulation module in the communication module. The main control single-chip microcomputer communicates with the communication demodulation module to obtain communication commands from the upper computer and communicates with the communication modulation module to send relevant feedback information to the upper computer. When the main control single-chip microcomputer communicates with the communication demodulation module, the frequency of the first communication interrupt signal is determined by the transmission time of the upper computer. In this case, the 2 Hz interrupt frequency does not serve the first communication interrupt, that is, when the data demodulation unit starts demodulating the communication carrier signal, the communication demodulation module sends the demodulated signal to the main control single-chip microcomputer and simultaneously triggers the main control single-chip microcomputer to work. When the main control single-chip microcomputer communicates with the communication modulation module to send relevant feedback information to the upper computer, the frequency of the first communication interrupt signal can be configured to be 2 Hz.

The second communication interrupt signal is used to trigger the main control single-chip microcomputer to communicate with the motor control module. The frequency of the second communication interrupt signal can be configured to be the same as the frequency of the first external interrupt signal. In this embodiment, the time interval for communication between the main control single-chip microcomputer and the motor control module is 0.5 seconds, so the frequency of the second communication interrupt signal is configured to be 2 Hz. In other embodiments, the frequency of the second communication interrupt signal can differ from the frequency of the first external interrupt signal, which can be set depending on the requirements and is not limited here.

The main control single-chip microcomputer can communicate with the communication demodulation module and the motor control module simultaneously or respectively at different times, which can be set depending on the requirements and is not limited here.

In some embodiments, the method for controlling a compass bird further includes the following steps.

Step 210: The motor single-chip microcomputer enters the second deep sleep mode when not processing a task.

Step 220: The motor single-chip microcomputer receives the first external interrupt signal and controls the motor and/or compass;

and/or, the motor single-chip microcomputer receives the second external interrupt signal and communicates with the main control single-chip microcomputer and/or the compass. In step 210, the method for controlling a motor single-chip microcomputer is similar to

that of the main control single-chip microcomputer. The motor single-chip microcomputer is controlled to enter the second deep sleep mode when it is not processing a task, allowing it to enter the second level, the third level, or deeper levels of dormancy. In this embodiment, the motor single-chip microcomputer can enter the fourth-level sleep mode to significantly reduce its power consumption.

In step 220, the first external interrupt signal and/or the second external interrupt signal can trigger the motor single-chip microcomputer to switch from the second deep sleep mode to the second working mode. The first external interrupt signal triggers the motor single-chip microcomputer to control the motor and/or compass. For instance, the first external interrupt signal triggers the motor single-chip microcomputer to control the motor for depth control. When a certain part of the towed cable needs to be at a specific underwater depth, the motor single-chip microcomputer of the compass bird in the part of the towed cable controls the motor to rotate, causing the compass bird to dive to the appropriate depth underwater and bringing the part of the towed cable to the specified depth underwater. Additionally, the first external interrupt signal triggers the motor single-chip microcomputer to control the compass for heading measurement. The lower the frequency of the first external interrupt signal, the lower the power consumption. In this embodiment, each compass operation lasts approximately 600 ms, no sampling occurs during wake-up every 0.5 seconds, and the waking period is about 10 ms. Using a 2-second sampling interval, the duty cycle is (600 ms+20 ms)/2 s=31%, reducing power consumption by 69%.

The motor single-chip microcomputer can control the motor and compass simultaneously or respectively at different times, which can be set depending on the requirements and is not limited here.

The second external interrupt signal can trigger the motor single-chip microcomputer to communicate with the main control single-chip microcomputer and the compass simultaneously or respectively at different times, which can be set depending on the requirements and is not limited here.

The first external interrupt signal and the second external interrupt signal can simultaneously or separately trigger the motor single-chip microcomputer to perform corresponding tasks, which can be set depending on the requirements and is not limited here.

In some embodiments, the method for controlling a compass bird further includes the following steps.

Step 310: The first comparison circuit detects whether the voltage of the first battery is greater than the switching reference voltage. The voltage range of the switching reference voltage corresponds to a voltage range when the remaining battery capacity of the first battery is 20%-30%.

Step 320: If the first comparison circuit detects that the voltage of the first battery is greater than the switching reference voltage, the first battery keeps working, and the second battery does not start. Step 330: If the first comparison circuit detects that the voltage of the first battery is

less than the switching reference voltage, the first battery keeps working and the second battery starts working.

In step 310, both the first battery and the second battery are lithium batteries. In this embodiment, when fully charged, the first battery has the voltage of about 7.4V. When the voltage of the first battery drops to about 4.5V, 70%-80% of the battery's capacity has been used, leaving only 20%-30%, and at this point, the first battery's capacity is nearly depleted. To ensure the normal operation of the compass bird, the backup battery (i.e., the second battery) needs to be activated to continue supplying power to the compass bird. By setting the first comparison circuit to detect if the voltage of the first battery is greater than 4.5V (this 4.5V is the switching reference voltage), the system can monitor whether the first battery's capacity is sufficient to ensure the normal operation of the compass bird. In other embodiments, if the full charge voltage of the first battery is 3.7V, when the voltage has 20%-30% remaining, the first battery has the voltage of around 2.3V, and in this case, the 2.3V is the switching reference voltage. This switching reference voltage is determined based on the usage requirements of the first battery and is not limited here.

The working current of the first comparison circuit is at the picoampere level, so the corresponding power consumption is very low. Therefore, the power consumption of the first comparison circuit is minimal, almost negligible. Compared to using the main control single-chip microcomputer to detect battery levels, using the first comparison circuit can significantly reduce the power consumption of the main control single-chip microcomputer.

In the step 320, when the first comparison circuit detects that the voltage of the first battery is greater than the switching reference voltage, it is indicated that the battery level of the first battery still meets the requirements for the compass bird's operation, and thus there is no need to activate the second battery.

In the step 330, when the first comparison circuit detects that the voltage of the first battery is less than the switching reference voltage, it is indicated that the battery level of the first battery is low and can affect the normal operation of the compass bird. To ensure the normal operation of the compass bird, the second battery needs to be activated at this point to increase the endurance of the compass bird.

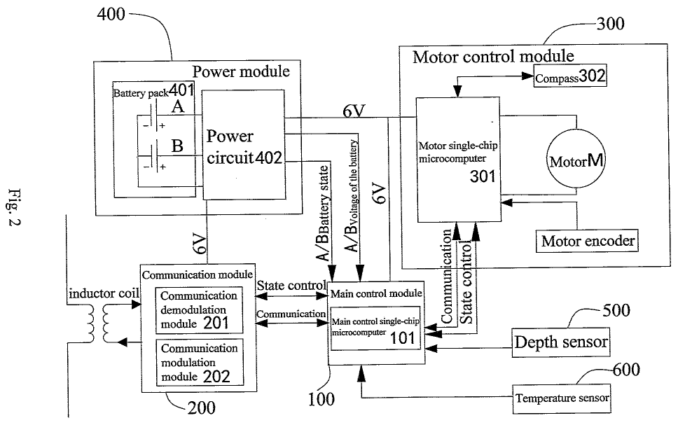

As shown in FIG. 2, it provides a structural diagram of a device for controlling a compass bird according to the embodiments of the present disclosure. The control device mainly includes a main control module 100 and a communication module 200 connected to the main control module 100. The main control module 100 includes a main control single-chip microcomputer 101, which enters the first deep sleep mode when not processing tasks and switches from the first deep sleep mode to the first working mode upon receiving an external interrupt signal.

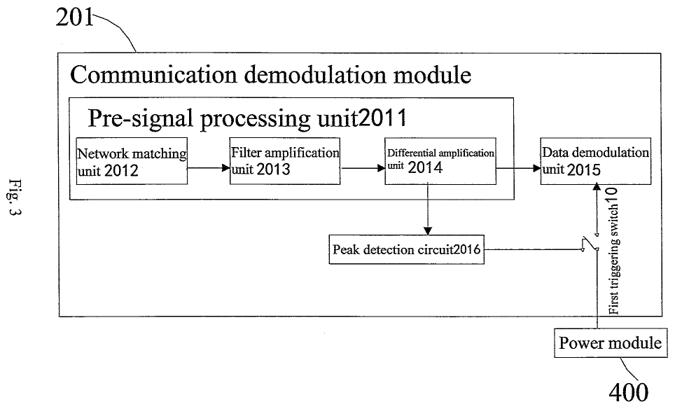

As shown in FIG. 3, the communication module 200 includes a communication demodulation module 201. The communication demodulation module 201 is connected to the main control single-chip microcomputer 101 and is used to demodulate the communication carrier signal from the upper computer. The communication demodulation module 201 includes a peak detection circuit 2016 and a data demodulation unit 2015. The peak detection circuit 2016 detects whether there is a communication carrier signal. If the peak detection circuit 2016 does not detect a communication carrier signal, the data demodulation unit 2015 does not start; if the peak detection circuit 2016 detects a communication carrier signal, the data demodulation unit 2015 starts to demodulate the communication carrier signal. The communication demodulation module 201 sends the demodulated signal to the main control single-chip microcomputer 101.

The main control single-chip microcomputer 101 includes an AD sampling module. When the main control single-chip microcomputer 101 receives the first external interrupt signal, the AD sampling module is used for AD sampling. The first external interrupt signal triggers the main control single-chip microcomputer 101 to perform AD sampling via the AD sampling module. The AD sampling module converts the analog signals from the depth sensor 500, the temperature sensor 600, the voltage of the battery module, and the working current into digital signals.

As shown in FIG. 2, the control device further includes a motor control module 300 connected to the main control module 100. The main control single-chip microcomputer 101 receives the second external interrupt signal and communicates with the communication module 200 and/or the motor control module 300.

As shown in FIG. 2, the motor control module 300 includes a motor single-chip microcomputer 301, motor M, and compass 302. Both the motor M and the compass 302 are connected to the motor single-chip microcomputer 301. The motor single-chip microcomputer 301 enters the second deep sleep mode when not processing tasks. The first external interrupt signal and/or the second external interrupt signal can trigger the motor single-chip microcomputer 301 to switch from the second deep sleep mode to the second working mode. The first external interrupt signal triggers the motor single-chip microcomputer 301 to control the operation of the motor M and/or the compass 302; and/or, the second external interrupt signal triggers the motor single-chip microcomputer 301 to communicate with the main control single-chip microcomputer 101 and/or the compass 302.

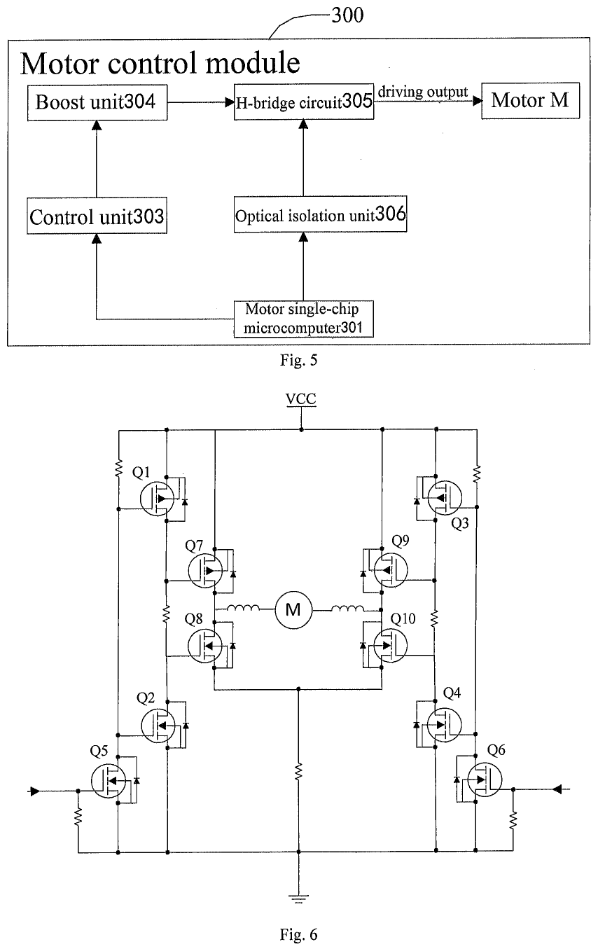

As shown in FIG. 5, the motor control module 300 further includes a control unit 303, a boost unit 304, an H-bridge circuit 305, and an optoelectronic isolation unit 306. The control unit 303 and the optoelectronic isolation unit 306 are both connected to the motor single-chip microcomputer 301. The boost unit 304 is connected to the control unit 303 and the H-bridge circuit 305. The optoelectronic isolation unit 306 is connected to the H-bridge circuit 305, and the H-bridge circuit 305 is connected to the motor M to drive the rotation of the motor M.

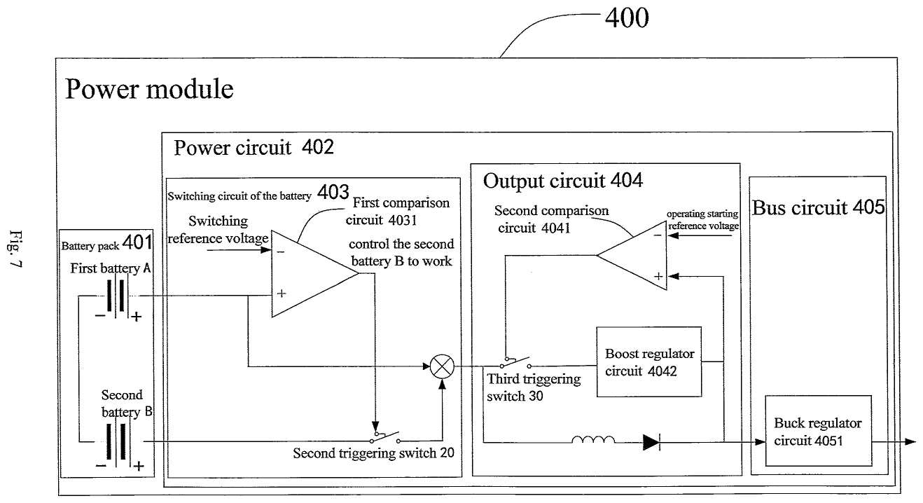

As shown in FIG. 6, it is a structural diagram of the H-bridge circuit provided by the exemplary embodiment of the present disclosure, where VCC in the circuit is the positive terminal, which is the supply voltage of the circuit, and Q1 to Q10 are all MOSFETs. In this embodiment, the H-bridge circuit is constructed of discrete MOSFETs, and a half-bridge is formed mainly by two driving MOSFETs Q7 and Q8, where the MOSFET model for Q7 is FDC6506, and the MOSFET model for Q8 is FDC6561. Under a starting voltage of 10V after boosting via the boost unit 304, the on-resistance of the FDC6561 is only 95 mΩ with a maximum continuous working current of 2.5 A. Under the same conditions, the on-resistance of the FDC6506 is 170 mΩ, with a maximum continuous current of 1.8 A. Therefore, under the operating conditions of the motor M, the internal resistance of the H-bridge circuit is very small, approximately 200 mΩ. At a working current of 100 mA, the power dissipation of motor M is about 2 mW. Thus, the power consumption of the H-bridge circuit built with discrete components is significantly reduced.

As shown in FIG. 2, the communication module 200 further includes a communication modulation module 202 which is connected to the main control single-chip microcomputer 101 and is used to modulate the feedback signals from the main control single-chip microcomputer 101 and then send them to the upper computer.

As shown in FIG. 3, the communication demodulation module 201 further includes a pre-signal processing unit 2011 which is used to process the communication carrier signal before demodulation. The peak detection circuit 2016 and the data demodulation unit 2015 are both connected to the pre-signal processing unit 2011. The peak detection circuit 2016 detects whether there is a communication carrier signal.

As shown in FIG. 3, pre-signal processing unit 2011 includes a network matching unit 2012, a filtering amplification unit 2013 connected to the network matching unit 2012, and a differential amplification unit 2014 connected to the filtering amplification unit 2013. The peak detection circuit 2016 and the data demodulation unit 2015 are both connected to the differential amplification unit 2014.

As shown in FIG. 2, the control device further includes a power module 400 connected to the main control module 100. The first trigger switch 10 is connected in series between the power module 400 and the data demodulation unit 2015. If the peak detection circuit 2016 does not detect a communication carrier signal and at this point the first trigger switch 10 is in the off state, the data demodulation unit 2015 is disconnected with the power module 400 and does not start. If the peak detection circuit 2016 detects a communication carrier signal, the peak detection circuit 2016 outputs a first control level to trigger the first trigger switch 10 to close. At this point, the power module 400 controls the startup of the data demodulation unit 2015 to demodulate the communication carrier signal and send the demodulated signal to the main control single-chip microcomputer 101. The first control level can be a high level or a low level, depending on the requirements.

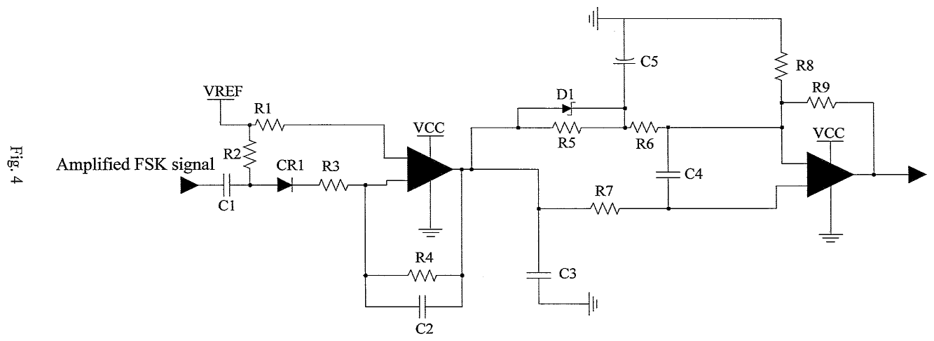

As shown in FIGS. 4, R1 to R9 in the peak detection circuit 2016 are resistors, C1 to C5 are capacitors, CR1 is a diode, D1 is a Schottky diode, VCC in the circuit is the positive terminal (which is the supply voltage of the circuit), VREF is 2.5V, and U1 and U2 are both comparator circuits. C1 and CR1 constitute the envelope signal of the communication analog signal, and U1, R4 and C2 constitute a low-pass filter and inverted output for the envelope signal. U2 and the associated discrete components constitute a positive output for the envelope signal. C1 is connected to the differential amplification unit 2014, and the output end of U2 is connected to the first trigger switch 10. If the peak detection circuit 2016 detects a communication carrier signal, U2 outputs a first control level to trigger the first trigger switch 10 to close, enabling the data demodulation unit 2015 to start to demodulate the communication carrier signal.

As shown in FIG. 7, the power module 400 includes a battery pack 401 and a power circuit 402. The power circuit 402 includes a switching circuit of the battery 403, an output circuit 404 in series with the switching circuit of the battery 403, and a bus circuit 405 in series with the output circuit 404.

The battery pack 401 includes a first battery A and a second battery B, where the second battery B is connected in parallel with the first battery A, and the first battery A is connected to the output circuit 404.

The switching circuit of the battery 403 includes a first comparison circuit 4031 and a second trigger switch 20. The switching reference voltage is input to the inverting input end of the first comparison circuit 403, the non-inverting input end of the first comparison circuit 4031 is connected to the first battery A, and the output end of the first comparison circuit 4031 is connected to the control terminal of the second trigger switch 20. The second battery B is connected to the output circuit 404 via the second trigger switch 20.

When the first comparison circuit 4031 detects that the voltage of the first battery A is greater than the switching reference voltage, the second trigger switch 20 is in the off state, the first battery A continues to work, and the second battery B does not start.

When the first comparison circuit 4031 detects that the voltage of the first battery A is less than the switching reference voltage, the first comparison circuit 4031 outputs a second control level to trigger the second trigger switch 20 to close, thereby the second battery B startsto work.

As shown in FIG. 7, the switching reference voltage of the first comparison circuit 4031 is 4.5V, allowing the first comparison circuit 4031 to determine whether the voltage of the first battery A is greater than 4.5V based on the switching reference voltage, and accordingly control whether the second battery B should start. This switching reference voltage can be provided by a voltage of a shunt circuit or by an ultra-low-power reference voltage chip, where the current in the shunt circuit is at the picoampere level, so the power of the shunt circuit can be ignored. It should be noted that the second control level can be a high level or a low level, which can be set depending on the requirements and is not limited here.

Additionally, it should be noted that when the voltage of the first battery A equals 4.5V, the first comparison circuit 4031 can output a second control level to control the starting of the second battery B or not output the second control level to make the second battery B not starting.

As shown in FIG. 7, the power circuit 402 further includes a bus circuit 405 connected to the output circuit 404. The output circuit 404 includes a first output branch and a second output branch. The input end of the first output branch is connected to the switching circuit of the battery 403, and the second output branch includes the second comparison circuit 4041, a boost regulator circuit 4042 and a third trigger switch 30. The non-inverting input end of the second comparison circuit 4041 is connected to the output end of the first output branch, the inverting input end of the second comparison circuit 4041 inputs the starting reference voltage, and the output end of the second comparison circuit 4041 is connected to the control terminal of the third trigger switch 30. The switching circuit of the battery 403 is connected to the boost regulator circuit 4042 through the third trigger switch 30. The second comparison circuit 4041 is used to detect whether the voltage of the switching circuit of the battery 403 is greater than the starting reference voltage, where the starting reference voltage is the output voltage value of the bus circuit 405.

When the second comparison circuit 4041 detects that the voltage of the switching circuit of the battery 403 is greater than the starting reference voltage, the third trigger switch 30 is in the off state, and the boost regulator circuit 4042 does not work.

when the second comparison circuit 4041 detects that the voltage of the switching circuit of the battery 403 is less than the starting reference voltage, the second comparison circuit 4041 outputs a third control level to trigger the third trigger switch 30 to close, making the boost regulator circuit 4042 work and output a voltage equal to the starting reference voltage.

As shown in FIG. 7, in this embodiment, the starting reference voltage in the second comparison circuit 4041 of the output circuit 404 is 6V provided by the voltage of the bus circuit 405, allowing the second comparison circuit 4041 to determine whether the voltage of the switching circuit of the battery 403 is greater than 6V and accordingly control whether the boost regulator circuit 4042 should start. When the second comparison circuit 4041 detects that the voltage of the switching circuit of the battery 403 is less than 6V, the boost regulator circuit 4042 boosts the voltage to output the voltage of 6V. It should be noted that the third control level can be a high level or a low level, which can be set depending on the requirements and is not limited here.

In other embodiments, when the voltage of the bus circuit 405 is 7V, 8V, or other voltage values, correspondingly, the starting reference voltage is 7V, 8V, or other voltage values, which is not limited here.

The bus circuit 405 includes a buck regulator circuit 4051, which is connected in series with the output circuit 404 to step down the voltage of the output circuit 404 to the voltage of 6V for the operation of other modules. The boost regulator circuit 4042 uses existing boost chips, and the buck regulator circuit 4051 uses existing buck chips. The general energy conversion efficiency of the boost chip is up to 85%, while the energy conversion efficiency of the buck chip is more than 90%, effectively reducing the voltage conversion power consumption of the power circuit 402 and further lowering the power consumption of the compass bird, at least reducing unnecessary energy consumption by 10%.

In the specification provided herein, a large number of specific details have been described. However, it can be understood that the embodiments of the present disclosure may be practiced without these specific details. In some instances, well-known methods, structures, and technologies have not been described in detail so as not to obscure the understanding of this specification.

Similarly, it should be understood that, for the sake of simplicity and aiding in the understanding of various disclosed aspects, sometimes the features of the embodiments of the present disclosure are grouped together within a single embodiment, figure, or description thereof. However, such a presentation of the disclosure should not be interpreted as requiring more features than those explicitly stated in each claim. Any combination of the features disclosed in this document (including accompanying claims, abstract, and figures) can be combined unless otherwise explicitly stated. Unless specifically stated otherwise, any feature disclosed can be replaced by another feature that serves the same, equivalent, or similar purpose.

It should be noted that the above-described embodiments are intended to illustrate rather than limit the present disclosure, and that those skilled in the art can design alternative embodiments without departing from the scope of the appended claims. In the claims, any reference signs between parentheses should not be construed as limiting the claims. The word “comprise/include” does not exclude the presence of elements or steps not listed in the claims.

The use of the words “a” or “an” before an element does not exclude the presence of multiple such elements. The present disclosure can be implemented by means of hardware including several distinct elements and by means of appropriately programmed computer. In the device claim enumerating several means, several of these means may be embodied by one and the same item of hardware. The mere presence of words such as “first,” “second,” and “third,” etc., in the description does not indicate any sequence unless otherwise specified. These words can be interpreted as names. The steps mentioned in the implementation examples should not be understood as being sequentially executed unless specifically indicated.

What is claimed is:

1. A method for controlling a compass bird, comprising:
a main control single-chip microcomputer entering a first deep sleep mode when not processing a task;
the main control single-chip microcomputer switching from the first deep sleep mode to a first working mode after receiving an external interrupt signal;
a peak detection circuit detecting whether there is a communication carrier signal;
a data demodulation unit not starting if the peak detection circuit detects that there is no communication carrier signal; and
the data demodulation unit starting to demodulate the communication carrier signal if the peak detection circuit detects that there is the communication carrier signal, and a communication demodulation module sending a demodulated signal to the main control single-chip microcomputer.

2. The method for controlling a compass bird according to claim 1, wherein the external interrupt signal includes a first external interrupt signal, and the main control single-chip microcomputer switching from the first deep sleep mode to a first working mode after receiving an external interrupt signal further comprises:
the main control single-chip microcomputer receiving the first external interrupt signal to perform AD sampling;
and/or, the external interrupt signal including a second external interrupt signal, and the main control single-chip microcomputer switching from the first deep sleep mode to a first working mode after receiving an external interrupt signal further comprises:
the main control single-chip microcomputer receiving the second external interrupt signal and communicating with a communication module and/or a motor control module.

3. The method for controlling a compass bird according to claim 2, wherein the second external interrupt signal includes a first communication interrupt signal and a second communication interrupt signal, and the main control single-chip microcomputer receiving the second external interrupt signal and communicating with a communication module and/or a motor control module further comprises:
the main control single-chip microcomputer receiving the first communication interrupt signal and communicating with the communication module; and
the main control single-chip microcomputer receiving the second communication interrupt signal and communicating with the motor control module.

4. The method for controlling a compass bird according to claim 2, wherein the method further comprises:
the motor single-chip microcomputer entering a second deep sleep mode when not processing a task;
the motor single-chip microcomputer receiving the first external interrupt signal and controlling operations of a motor and/or a compass;
and/or, the motor single-chip microcomputer receiving the second external interrupt signal and communicating with the main control single-chip microcomputer and/or the compass.

5. The method for controlling a compass bird according to claim 1, wherein the method further comprises:
a first comparison circuit detecting whether a voltage of a first battery is greater than a switching reference voltage, wherein a voltage range of the switching reference voltage corresponds to a voltage range when the remaining battery capacity of the first battery is 20%-30%;
the first battery keeping working and a second battery not starting if the first comparison circuit detects that the voltage of the first battery is greater than the switching reference voltage; and
the first battery keeping working and the second battery starting working if the first comparison circuit detects that the voltage of the first battery is less than the switching reference voltage.

6. A device for controlling a compass bird, comprising:
a main control single-chip microcomputer, configured to enter a first deep sleep mode when not processing a task, and switch from the first deep sleep mode to a first working mode after receiving an external interrupt signal;
a communication module comprising a communication demodulation module connected to the main control single-chip microcomputer and configured to demodulate the communication carrier signal from an upper computer, wherein the communication demodulation module comprises a peak detection circuit and a data demodulation unit, and the peak detection circuit is configured to detect whether there is a communication carrier signal;
if the peak detection circuit detects that there is no communication carrier signal, the data demodulation unit does not start; and
if the peak detection circuit detects that there is the communication carrier signal, the data demodulation unit starts to demodulate the communication carrier signal, and the communication demodulation module sends a demodulated signal to the main control single-chip microcomputer.

7. The device for controlling a compass bird according to claim 6, wherein the main control single-chip microcomputer includes an AD sampling module, the external interrupt signal includes a first external interrupt signal, and when the main control single-chip microcomputer receives the first external interrupt signal, the AD sampling module performs AD sampling;
and/or, the external interrupt signal includes a second external interrupt signal, and the main control single-chip microcomputer receives the second external interrupt signal to communicate with the communication module and/or motor control module.

8. The device for controlling a compass bird according to claim 7, wherein the motor control module includes a motor single-chip microcomputer, a motor, and a compass, the motor and the compass both connect to the motor single-chip microcomputer, and the motor single-chip microcomputer enters a second deep sleep mode when not processing a task;
the motor single-chip microcomputer receives the first external interrupt signal and controls operations of the motor and/or compass;
and/or, the motor single-chip microcomputer receives the second external interrupt signal and communicates with the main control single-chip microcomputer and/or the compass.

9. The device for controlling a compass bird according to claim 6, wherein, the device for controlling a compass bird further comprises a power module, and a first trigger switch is connected in series between the power module and the data demodulation unit;
the communication demodulation module further includes a pre-signal processing unit configured to process the communication carrier signal before demodulation, and the peak detection circuit and the data demodulation unit are both connected to the pre-signal processing unit; and
if the peak detection circuit detects that there is the communication carrier signal, the peak detection circuit outputs a first control level to close the first trigger switch to cause the data demodulation unit to start.

10. The device for controlling a compass bird according to claim 9, wherein the pre-signal processing unit includes a network matching unit, a filter amplification unit connected to the network matching unit, and a differential amplification unit connected to the filter amplification unit, and the peak detection circuit and the data demodulation unit are both connected to the differential amplification unit.

11. The device for controlling a compass bird according to claim 9, wherein the power module includes a battery pack and a power circuit, and the power circuit includes a switching circuit of the battery and an output circuit connected in series with the switching circuit of the battery;
the battery pack includes a first battery and a second battery, the second battery is connected in parallel with the first battery, and the first battery is connected to the output circuit;
the switching circuit of the battery includes a first comparison circuit and a second trigger switch, wherein a switching reference voltage is input to the inverting input end of the first comparison circuit, the non-inverting input end of the first comparison circuit is connected to the first battery, the output end of the first comparison circuit is connected to the control end of the second trigger switch, the second battery is connected to the output circuit via the second trigger switch, and the first comparison circuit is configured to detect whether the voltage of the first battery is greater than the switching reference voltage, wherein a voltage range of the switching reference voltage corresponds to a voltage range when the remaining battery capacity of the first battery is 20%-30%;
if the first comparison circuit detects that the voltage of the first battery is greater than the switching reference voltage, the second trigger switch is in an off state, the first battery keeps working and the second battery does not start; and
if the first comparison circuit detects that the voltage of the first battery is less than the switching reference voltage, the first comparison circuit outputs a second control level to trigger the second trigger switch to close, thereby the second battery starts to work.

12. The device for controlling a compass bird according to claim 11, wherein the power circuit further comprises a bus circuit connected to the output circuit, the output circuit includes a first output branch and a second output branch, an input end of the first output branch is connected to the battery switching circuit, the second output branch includes a second comparison circuit, a boost regulator circuit, and a third trigger switch, a non-inverting input end of the second comparison circuit is connected to an output end of the first output branch, a starting reference voltage is input to an inverting input end of the second comparison circuit, an output end of the second comparison circuit is connected to a control end of the third trigger switch, the battery switching circuit is connected to the boost regulator circuit via the third trigger switch, and the second comparison circuit is configured to detect whether the voltage of the battery switching circuit is greater than the starting reference voltage, wherein the starting reference voltage is the output voltage of the bus circuit;
if the second comparison circuit detects that the voltage of the battery switching circuit is greater than the starting reference voltage, the third trigger switch is in an off state, and the boost regulator circuit does not work; and
if the second comparison circuit detects that the voltage of the battery switching circuit is less than the starting reference voltage, the second comparison circuit outputs a third control level to close the third trigger switch so that the boost regulator circuit works.
